(19) United States
(12) Patent Application Publication
(10) Pub. No.: US 2024/0328597 A1
(43) Pub. Date: Oct. 3, 2024

(54) A LIGHT DIRECTING ARRANGEMENT

(71) Applicant: SIGNIFY HOLDING B. V., EINDHOVEN (NL)

(72) Inventors: QI LIU, SHANGHAI (CN); CHENG JI, SHANGHAI (CN); YANYAN QU, SHANGHAI (CN)

(21) Appl. No.: 18/579,537

(22) PCT Filed: Jul. 25, 2022
(86) PCT No.: PCT/EP2022/070792

§ 371 Date: Jan. 16, 2024

(30) Foreign Application Priority Data
Jul. 28, 2021 (WO) PCT/CN2021/109073
Sep. 9, 2021 (EP) 21195667.7

(51) Int. Cl. F21V 11/02; F21W 131/10

(52) U.S. Cl. CPC F21V 11/02; F21W 2131/10

(57) ABSTRACT

A light directing arrangement (52) is provided for directing output light from a lighting unit (50), comprising an arrangement of panels (10). The panels (10) form a funnel-type structure for limiting beam spreading from a light emitting area of the lighting unit (50). At least one panel (10) has openings in opposite surfaces (14, 22), with direct light paths between the openings blocked but an air flow passage (32) is provided between the openings. In this way, forces experienced in windy conditions are reduced.

### FIELD OF THE INVENTION

This invention relates to a light directing arrangement, for example for limiting the range of angles from which light is emitted from a luminaire.

### BACKGROUND OF THE INVENTION

It is well known to use a light directing element in the form of a shield or louver structure, to reduce glare from the light output of a luminaire. The shield or louver structure limits the range of angles over which light is output from the luminaire, so that a direct view of the light source is prevented from certain angles.

The need to reduce glare is for example important in various lighting applications such as outdoor stadium lighting and road lighting as well as indoor lighting. In outdoor lighting applications, adding a shield or louver may result in forces on the luminaire when there are windy conditions. If the louver panels face the incoming wind direction, there are wind forces acting on the luminaire.

It has been recognized that when adding a louver or shield, it may be necessary to strengthen the overall structure in order to ensure the stability of the luminaire. The conventional way to strengthen the structure is to add mechanical strengthening elements, but this results in increased cost, weight, and may result in unnecessary light blocking.

WO 2020238263 A1 discloses a light-shading and air-discharge device, comprising a ventilation plate and a light-shading plate, which are arranged opposite each other at an interval. A ventilation opening is provided in the ventilation plate, and the ventilation opening is formed by punching the ventilation plate; and the vertical projection of the light-shading plate on the ventilation plate covers the ventilation opening. The light-shading plate and the ventilation plate are both common flat plates without a special design.

There is therefore a need for an improved design of light directing arrangement.

### SUMMARY OF THE INVENTION

The invention is defined by the claims.

According to examples in accordance with an aspect of the invention, there is provided a light directing arrangement for directing output light from a lighting unit, comprising an arrangement of panels, wherein at least one panel comprises:
a first face having a plurality of first openings;
a second face, spaced from the first face, and having a plurality of second openings; and
a guide structure between the first and second faces for blocking direct light paths between the first and second openings and allowing an air flow between the first and second openings,
wherein the panels form a funnel-type structure for arranging around or over a light emitting area of the lighting unit for limiting beam spreading from the light emitting area

This light directing arrangement is for example for blocking a direct line of sight to the light source of a lighting unit, for reducing glare. It is for example a louver structure. One or more panels allow an air flow through the panel but without allowing a direct light path. In this way, when adding the light directing arrangement to a lighting unit, the risk of damage due to forces resulting from air flows (such as outdoor wind forces) is reduced.

The panels together define a funnel-type structure for arranging around a light emitting area of the lighting unit. The funnel-type structure limits the angles with which light is able to be emitted from the lighting unit, thereby limiting beam spreading.

The funnel-type structure may have parallel sides, and hence have a generally prismatic shape (with any desired base shape), such as a square-based prism or a rectangular-based prism. However, the sides do not need to be parallel. The funnel-type structure may diverge (with a larger open end than the end at the light emitting area) or it may converge (with a smaller open end that the end at the light emitting area), thus forming a pyramid type funnel structure. The panels are preferably flat for ease of manufacture, but they could instead be curved.

The panel design has a simple structure of two faces, with air flow paths defined between the faces but without disturbing the desired light blocking function.

The openings of the first face may each be formed by stamping, wherein resulting first stamped portions extend into the space between the first and second faces and form a first part of the guide structure, and wherein the openings of the second face are also formed by stamping, wherein resulting second stamped portions extend into the space between the first and second faces and form a second part of the guide structure.

This enables a simple stamping/punching process to form stamped portions which then form the guide structure. The stamping/punching process creates light blocking elements while also providing air flow passages.

Respective pairs of first and second stamped portions for example meet in the space between the first and second faces. Thus, the stamped portions meet to define a light blocking structure which extends between the two faces, while also creating an air guiding path.

The respective pairs of first and second stamped portions may instead overlap in the space between the first and second faces. The overlap provides some tolerance to make sure the stamped portions block a light path.

The first openings for example substantially align with the second openings in a direction perpendicular to the first and second faces, and the guide structure provides an air flow path between each first opening and a non-aligned one of the second openings. The openings are “substantially” aligned in that the guide structures for those openings meet or overlap in the middle.

Thus, the air path is not between the pairs of aligned openings; this path is blocked by the guide structure. Instead, the air flow path is staggered by the guide structure.

The first and second faces may each comprise a metal sheet. This provides a low cost design.

The first and second faces may each comprise a punched sheet. The punching creates the openings as well as the guide structure.

The first and second faces may comprise a single bent metal sheet. This provides a low cost structure formed from a single sheet.

The first and second faces for example each have a thickness in the range 0.5 mm to 2 mm. Thus, they may be formed of a low cost thin sheet, for example with thickness around 1 mm.

Each panel for example has a thickness in the range 3 mm to 10 mm. Thus, the panels do not take up significant space in their thickness direction and can define a thin frame around a luminaire light output area. The thickness is for example around 5 mm.

The light directing arrangement may comprise a set of four panels for positioning around a light output area. The combination of panels forms a funnel type structure which limits the range of light emission angles all around a light output area of a luminaire. The funnel design blocks a direct view of the light output area from certain angles. The funnel for example has parallel top and bottom faces and parallel side faces.

The light directing arrangement may comprise a set of panels forming a grid, with each grid opening for positioning around a light output area.

The invention also provides a lighting unit comprising:
a housing having a light emitting area; and
the light directing arrangement defined above arranged around the light emitting area, such that the panels form a funnel-type structure for limiting beam spreading from the light emitting area.

The lighting unit is for example an outdoor lighting unit.

These and other aspects of the invention will be apparent from and elucidated with reference to the embodiment(s) described hereinafter.

### BRIEF DESCRIPTION OF THE DRAWINGS

For a better understanding of the invention, and to show more clearly how it may be carried into effect, reference will now be made, by way of example only, to the accompanying drawings, in which:

FIG. 1 shows a panel suitable for forming at least part of a light directing arrangement;

FIG. 2 shows a side view of the panel of FIG. 1 in cross section;

FIG. 3 shows an enlarged view of a portion of a first design of the panel, in cross section;

FIG. 4 shows an enlarged view of a portion of a second design of the panel, in cross section;

FIG. 5 shows an outdoor lighting unit having a light directing arrangement; and

FIG. 6 shows an alternative design of light directing arrangement.

### DETAILED DESCRIPTION OF THE EMBODIMENTS

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

The invention provides a light directing arrangement for directing output light from a lighting unit, comprising an arrangement of panels. The panels form a funnel-type structure for limiting beam spreading from a light emitting area of the lighting unit. At least one panel has openings in opposite surfaces, with direct light paths between the openings blocked but air flow passages provided between the openings. In this way, forces experienced in windy conditions are reduced.

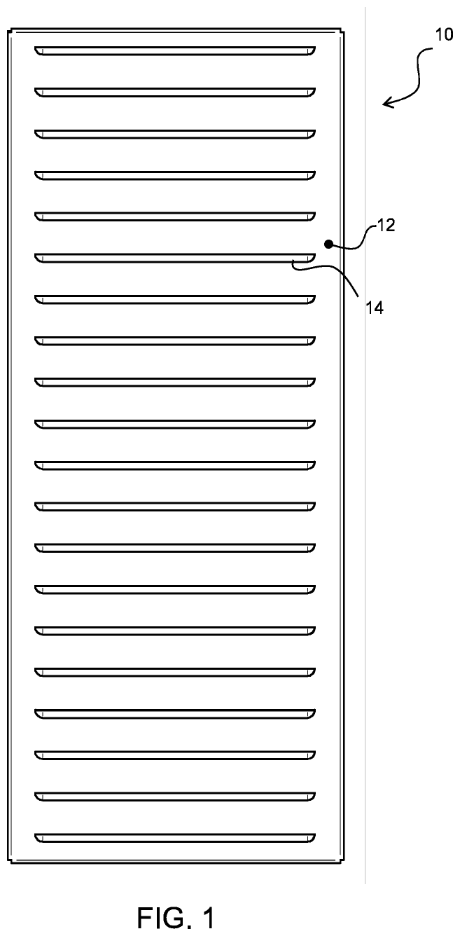

One panel suitable for forming at least part of a funnel-type light directing arrangement is shown in FIG. 1.

The panel comprises two parallel opposite faces. A first face 12 is seen in FIG. 1. The first face 12 comprises a plurality of first openings 14.

A second face (not visible in FIG. 1) has a corresponding plurality of openings. However, there is no direct light path between the openings in the two faces. Thus, the panel functions as a light blocking panel (as if there were no openings). Within the panel, there is a guide structure which blocks the light between the faces but allows an air flow between the openings.

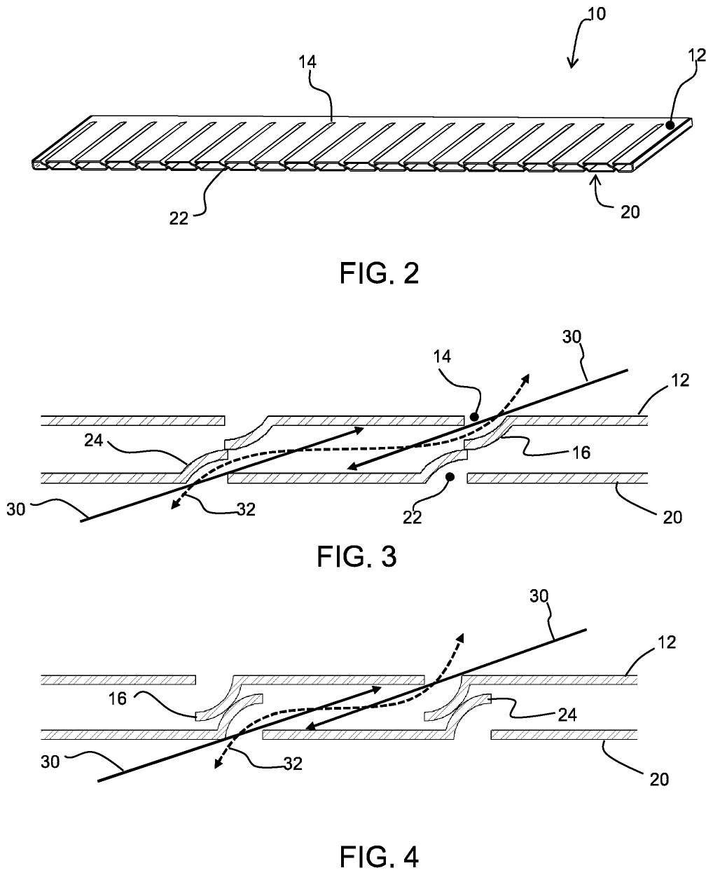

FIG. 2 shows a side view of the panel in cross section. It shows the first face 12 at the top and the second face 20 at the bottom. The second face has a corresponding set of openings 22.

FIG. 3 shows an enlarged view of a portion of the panel, in cross section. It shows a first possible design for the guide structure between the first and second faces.

The first face 12 comprises first openings 14 which are formed by a stamping or punching process and result in first stamped portions 16. These stamped portions comprise the material that filled the openings before the stamping or punching process. The stamping or punching process starts with a continuous uniform sheet.

The first stamped portions 16 extend into the space between the first and second faces 12, 20 and form a first part of the guide structure.

Similarly, the openings 22 of the second face 20 are also formed by stamping or punching which results in second stamped portions 24. The second stamped portions 24 also extend into the space between the first and second faces and form a second part of the guide structure.

As shown by arrows 30, a direct light path between openings is blocked by the guide structure. The opening arrays of the two faces are almost aligned in this example (they are aligned such that the stamped portions meet), but a light path between the closest pairs of openings is blocked by the guide structure. One stamped portion 16 connects to the opening 14 at one edge and the other stamped portion 24 connects to the opening 22 at the opposite edge. In this way, the guide structure is a diagonal structure which blocks the light path between the pair of openings.

The narrow spacing between the faces means that the light path between staggered openings is also blocked. However, an air flow path is provided as shown by arrow 32.

The faces may be provided with light absorbing surfaces, at least on the inner surfaces, to reduce indirect light paths (i.e., with reflections) between the openings. Thus, the panel functions as a light blocking panel. One or both outer surfaces of the panel may be reflective, to reduce light loss at the output of the luminaire.

The panel design enables a simple stamping/punching process to form stamped portions which then form the guide structure. The punching process creates light blocking elements while also providing air flow passages.

In the example of FIG. 3, the pairs of first and second stamped portions 16, 24 meet in the space between the first and second faces 12, 20.

FIG. 4 shows a variation in which respective pairs of first and second stamped portions 16, 24 overlap in the space between the first and second faces 12, 20. However, they again form a diagonal structure between the closely aligned openings.

The first and second faces for example each comprise a metal sheet. This provides a low cost design and enables a low cost punching process to creating the openings as well as the guide structure in a single operation.

The faces may be formed as separate sheets which are then mounted to form the overall panel. However, the first and second faces may instead comprise a single sheet which is punched and then bent over to form the parallel first and second faces.

The metal sheet for example has a thickness of around 1 mm (e.g. 0.5 mm to 2 mm) and the overall panel has a thickness of around 5 mm (e.g. 3 mm to 10 mm).

The spacing between the sheets, the thickness of the sheets, and the pitch between the openings is designed to prevent direct light paths between the openings. This can be understood from the light path arrows 30 in FIGS. 3 and 4. The spacing between the faces is for example in the range 2 mm to 5 mm and the pitch of the openings is for example in the range 10 mm to 50 mm.

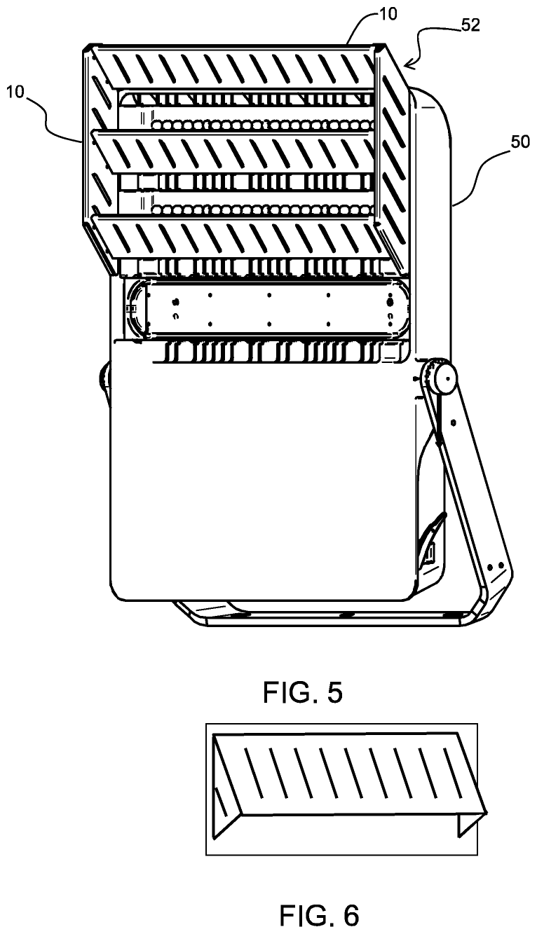

FIG. 5 shows an outdoor lighting unit 50 in the form of a luminaire having a light output face surrounded by a light directing arrangement 52. The light directing arrangement comprises a set of the panels 10 described above. In this example, there are five panels, forming a grid with two openings, each opening extending around a respective light output area.

In this example, the general outer shape of the combined panel arrangement is a rectangular-based prism (but truncated non-perpendicularly to the prism height axis, so that a principal beam angle is not orthogonal to the light emitting area). Of course, the shape and principal direction of the light directing arrangement may be different.

There may be at least four panels to form a funnel structure for positioning around a light output area, or there may be a set of more than four panels (as in FIG. 5) forming a grid of funnels. The funnels limit the range of light emission angles from the enclosed light output area of the luminaire. In particular, the funnel design blocks a direct view of the light output area from certain angles, thereby reducing glare.

In the examples above, all panels of the light guiding structure have the same design. However some panels may instead be solid panels. For example, it may only be needed to provide the panels allowing air to flow through facing certain directions (e.g. not facing downwardly or upwardly). Thus, the overall light guiding structure may have different panel designs.

The panels may form a prism shape as in the example of FIG. 5, but they may instead form a prism shape which diverges or converges.

The funnel-type structure also does not need to project forwardly from the full periphery of the light emitting area. For example, FIG. 6 shows an alternative design of light directing arrangement which has only a top panel and two side panels. The funnel-type structure defines a downwardly pointing light output direction in this example, and the funnel shape may be considered to diverge from a line at the top to an open bottom. The funnel shape may in this case be considered to include the light emitting face.

Thus, a funnel-type structure is any arrangement of panels which performs a light directing or limiting function, and wherein at least some panels project outwardly from the light emitting area (or from a region around the light emitting area).

The stamped design is only one possible option. The faces may instead have openings with the opening material removed, and a separate guide structure may be sandwiched between the opposite faces.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality.

The mere fact that certain measures are recited in mutually different dependent claims does not indicate that a combination of these measures cannot be used to advantage.

If the term “adapted to” is used in the claims or description, it is noted the term “adapted to” is intended to be equivalent to the term “configured to”.

Any reference signs in the claims should not be construed as limiting the scope.

1. A light directing arrangement for directing output light from a lighting unit, comprising an arrangement of panels, wherein at least one panel comprises:
a first face having a plurality of first openings;
a second face, spaced from the first face, and having a plurality of second openings; and
a guide structure between the first and second faces for blocking direct light paths between the first and second openings and allowing an air flow between the first and second openings,
wherein the panels form a funnel-type structure for arranging around or over a light emitting area of the lighting unit for limiting beam spreading from the light emitting area;
wherein the openings of the first face are each formed by stamping, wherein resulting first stamped portions extend into the space between the first and second faces and form a first part of the guide structure, and wherein the openings of the second face are each formed by stamping, and wherein resulting second stamped portions extend into the space between the first and second faces and form a second part of the guide structure.

2. The light directing arrangement of claim 1, wherein respective pairs of first and second stamped portions meet in the space between the first and second faces.

3. The light directing arrangement of claim 1, wherein respective pairs of first and second stamped portions overlap in the space between the first and second faces.

4. The light directing arrangement of claim 1, wherein the first openings substantially align with the second openings in a direction perpendicular to the first and second faces, and wherein the guide structure provides an air flow path between each first opening and a non-aligned one of the second openings.

5. The light directing arrangement of claim 1, wherein the first and second faces each comprises a metal sheet.

6. The light directing arrangement of claim 5, wherein the first and second faces each comprise a punched sheet.

7. The light directing arrangement of claim 5 or 6, wherein the first and second faces comprise a single bent metal sheet.

8. The light directing arrangement of claim 1, wherein the first and second faces each have a thickness in the range 0.5 mm to 2 mm.

9. The light directing arrangement of claim 1, wherein said at least one panel has a thickness in the range 3 mm to 10 mm.

10. The light directing arrangement of claim 1, comprising a set of at least four panels for positioning around a light output area.

11. The light directing arrangement of claim 1, comprising a set of panels forming a grid, with each grid opening for positioning around a light output area.

12. A lighting unit comprising:
a housing having a light emitting area; and
the light directing arrangement of claim 1 arranged around the light emitting area, such that the panels form a funnel-type structure for limiting beam spreading from the light emitting area.

13. The lighting unit of claim 12, comprising an outdoor lighting unit.
